(19) United States
(12) Patent Application Publication
(10) Pub. No.: US 2026/0238501 A1
(43) Pub. Date: Aug. 13, 2026

(54) PROPAGATING BLOCKCHAIN MESSAGES

(71) Applicant: nChain Licensing AG, Zug (CH)

(72) Inventors: Jack Owen DAVIES, London (GB); Mathieu DUCROUX, London (GB); Craig Steven WRIGHT, London (GB)

(21) Appl. No.: 19/156,800

(22) PCT Filed: Feb. 1, 2024
(86) PCT No.: PCT/EP2024/052502

§ 371 Date: Aug. 14, 2025

(30) Foreign Application Priority Data
Feb. 20, 2023 (GB) 2302370.8

(51) Int. Cl. H04L 9/00; H04L 9/40

(52) U.S. Cl. CPC H04L 9/50; H04L 63/0428

(57) ABSTRACT

A computer-implemented method of propagating blockchain messages, wherein a blockchain network comprises a plurality of blockchain nodes, wherein each blockchain node is associated with a respective set of blockchain nodes, wherein the method is performed by a first blockchain node and comprises:
making a first blockchain message available to each blockchain node belonging to the respective set of blockchain nodes associated with the first blockchain node, wherein the respective set of blockchain nodes comprises some but not all of the plurality of blockchain nodes.

### CROSS REFERENCE TO RELATED APPLICATIONS

This application is the U.S. National Stage of International Application No. PCT/EP2024/052502 filed on Feb. 1, 2024, which claims the benefit of United Kingdom Patent Application No. 2302370.8, filed on Feb. 20, 2023, the contents of which are all incorporated herein by reference in their entireties.

### TECHNICAL FIELD

The present disclosure relates to methods of propagating blockchain transactions to nodes of a blockchain network.

### BACKGROUND

The Internet Protocol (IP) suite currently has two competing technical designs IPv4 and IPv6, corresponding to versions 4 and 6 of the IP respectively, for assigning IP addresses and routing packets of data between a sender and receiver over the Internet. A key distinction between the two is that IPv6 is accompanied by a range of IP address types, such as unicast, anycast and multicast.

The most widely adopted type of address is unicast. Unicast allows to transmit a packet to a single recipient. This is usually enough for most client services and applications. However, two other types of address are used for specialised enterprise networks: multicast and anycast. Anycast allows for a single operation to transmit a packet to one recipient out of a set of recipients. It is not available for IPv4 (it could be implemented with some workarounds), while it is natively supported by IPv6. Multicast allows for a single operation to transmit a packet to multiple recipients. It is optional (and not widely adopted) in IPv4, while it is natively part of the IPv6 specifications.

IP multicast enables a source host to transmit IP packets to one or more destination hosts identified by a single group address. The packets transmitted are replicated inside the IP network by routers at the point where paths diverge such that a single packet destined for a particular group has to be sent by the source host, resulting in the most efficient delivery of data to multiple receivers. One link may transmit to one or more multicast groups and a host may be part of more than one multicast group. Any host, regardless of whether it is a member of a multicast group, may send packets to it, but only the group members receive the packets.

IP multicast is designed for applications and services in which the same data needs to simultaneously reach many hosts connected to a network. Example applications include videoconferencing, corporate communications, and the distribution of news, software, stock quotes. The source host could support these applications by learning the IP addresses of N destination hosts, establishing N connections with them, and transmitting N copies of each packet. In contrast, IP multicast is more efficient because the source host has to learn a single group address and transmit a single packet to reach the N destination hosts. IP multicast differs from broadcast in that packets are not sent to an entire subnetwork but rather to a selected group of hosts that can be on different subnetworks and have registered themselves to the group. Another difference is that while broadcast only supports one-to-many types of communication, multicast also supports many-to-many types of communication. Any IP network concerned with reducing network resource overhead for one-to-many or many-to-many data or multimedia applications with multiple receivers benefits from multicast.

While both IPv4 and IPv6-based network support IP multicast but in this paper, the limited address space of IPv4 limits the IPv4 multicast's ability to reach the increasing number of Internet-attached devices. In addition, the common use of Network Address Translation (NAT) vehicles that convert public IPv4 addresses to private addresses makes it very difficult, if not impossible, to support certain applications that use multicast connectivity. Globally unique IPv6 addresses eliminates the needs for NAT boxes and simplify multicast communication between hosts. In particular, IPv6's larger address space reduces the possibility that separate multicast streams from different sources use the same group address and interfere. IPv6 multicast also more clearly defines domain control, the ability to prevent multicast leaks outside of an administrative region, and makes it easier to allocate and manage multicast groups.

As FIG. 3 illustrates, the basic format of an IPv6 multicast address includes the following elements:
Prefix: all IPv6 multicast addresses begin with the hex 0xFF to identify them as multicast addresses.
Flags: indicates how the address was allocated or if it might contain additional information. The Internet Assigned Numbers Authority (IANA) has allocated a set of permanently assigned multicast addresses for specific functions. Other flags include: the T flag for temporarily assigned address, the P flag for addresses derived from a unicast-based IPv6 network prefix, the R flag to signal that a rendezvous-point (RP) address is embedded.
Scope: constrains the distance a multicast packet can travel. This prevents multicast packets from crossing administrative network boundaries and traversing links and networks in which they don't belong.
Group ID: identifies a specific multicast group address (belonging to a host interface).

Blockchain networks, such as Bitcoin, typically use a distributed network of nodes to produce new blocks containing transactions. These blocks and transactions are propagated rapidly across the entire network using a peer-to-peer (P2P) messaging protocol. The protocol uses a ‘flooding’ approach that attempts to forward all new messages to all peers connected to a given node.

### SUMMARY

The P2P messaging protocol in Bitcoin and some other blockchains ensures that each new block or transaction will reach all other nodes in the network in a timely fashion, regardless of the network structure. This is because the protocol ensures that each node tries to forward new messages to all other nodes to which they are connected. This is inefficient because it generates a large amount of redundant network traffic.

In reality, the topology of a blockchain network is that of a highly connected graph consisting of just a few significant nodes. In such a network, sometimes referred to as a ‘small world’ or a near-complete graph, each node is connected to the majority of all other nodes. At its extreme, the network may be saturated such that all nodes are connected to one another.

The high connectivity of the blockchain network impacts the efficiency of the P2P messaging protocol because it introduces significant redundancy. Consider a connection-saturated snapshot of the blockchain network consisting of n nodes and generating blocks and transactions at a total rate of m per second. The nature of the P2P protocol means that each node may send up to (n−1)·m messages per second, which creates an upper limit of roughly n·(n−1)·m on the instantaneous total network traffic rate. This is significantly higher than the theoretical minimum of n·m messages per second required for the network to function, corresponding to the scenario that all new blocks and transactions are originated by just one node. The ratio of the upper and lower bounds is ~n, which is an order of magnitude difference even with just a handful of nodes in the network.

This interaction between the current P2P messaging protocol and the empirical topology of the blockchain network therefore creates a redundancy of up to (n−2)·n·m=(n−1)·(n·m)−(n·m) messages per second. In practice, the lower bound is unlikely to occur (since not all blocks and transactions tend to originate from a single node), but there will nearly always be a significant redundancy between the upper bound worst case network traffic and the theoretical minimum traffic for any given network state. These redundant messages unnecessarily increase the burden of operating a blockchain node and therefore decrease the overall efficiency of the network.

It would therefore be advantageous to reduce the total instantaneous traffic on the blockchain network by modifying the P2P messaging protocol such that new block and transaction messages are not unnecessarily duplicated.

According to one aspect disclosed herein, there is provided a computer-implemented method of propagating blockchain messages, wherein a blockchain network comprises a plurality of blockchain nodes, wherein each blockchain node is associated with a respective set of blockchain nodes, wherein the method is performed by a first blockchain node and comprises:
making a first blockchain message available to each blockchain node belonging to the respective set of blockchain nodes associated with the first blockchain node, wherein the respective set of blockchain nodes comprises some but not all of the plurality of blockchain nodes.

According to one aspect disclosed herein, there is provided a computer-implemented method of obtaining blockchain messages, wherein a blockchain network comprises a plurality of blockchain nodes, wherein the method is performed by a second blockchain node and comprises:
subscribing to a respective network address associated with a respective set of blockchain nodes; and
obtaining a first blockchain message sent to the respective network address.

Embodiments of the present disclosure provide several advantages over the existing ‘flooding’ approach of forwarding all messages to all nodes. For example, embodiments improve the efficiency of the blockchain P2P protocol and reduce redundant or duplicated network traffic. Embodiments also allow for hierarchy in the node network based on capability, meaning some nodes can choose to take on more of the propagation burden than others.

Embodiments disclosed herein allow for network traffic to be ‘sharded’, or partitioned, based on the content of the traffic or the order in which it arrives. In the case of blockchain transactions, the ordering used to partition traffic may be related to the order in which the transactions appear in a block and its associated Merkle tree.

Overlaps in partitioned traffic may also be created using the described embodiments to build resilience when transferring data to many parties. These overlaps represent a compromise between redundancy and resiliency in data propagation, whereby the redundancy is still minimised with respect to existing messaging protocols. In effect, a single large message, e.g. a block composed of many transactions, or e.g. a large transaction composed of many packets, can be propagated more efficiently to a recipient by using these overlaps in partitioning. This splits the load in propagating the traffic amongst a multiplicity of senders, which increases the resilience of the propagation mechanism to the failure of a subset of the senders, since dropped connections or failed packets will be mitigated by the overlap between different traffic partitions. In other words, some embodiments create ‘virtual’ propagation connections between each receiver and a multiplicity of senders which are more robust than each individual sender-receiver connection in the network. This is analogous to a RAID (redundant array of inexpensive disks) system in virtualised data storage systems.

A feature of the Bitcoin network, as per the Bitcoin white paper, is that “New transactions are broadcast to all nodes”. Embodiments of the present disclosure achieve this same goal, and therefore are compatible with the original Bitcoin protocol, but with minimised redundancy in message propagation.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 schematically illustrates the basic format of an IPv6 multicast address, and

FIG. 4 schematically illustrates an example system for propagating messages.

### DETAILED DESCRIPTION OF EMBODIMENTS

### 1. Propagating Blockchain Messages

An example system for implementing embodiments of the present disclosure is shown in FIG. 4. The system 400 includes a plurality of blockchain nodes 104. Whilst only four nodes 104 are shown (nodes 104a-d), in general the system 400 may include any number, e.g. all, blockchain nodes 104 of a blockchain network 106. A first blockchain node (e.g. “Blockchain Node A” 104a) is configured to determine whether to propagate a blockchain-related message to one or more other blockchain nodes 104 and/or to which other node(s) 104 the message is to be propagated. The message may be or comprise one or more blockchain transactions 152. In some examples the message is a single transaction. The message may be or comprise a blockchain block 151. The message may include the entire block, i.e. block header and a corresponding set of transactions, or only the block header.

Propagating a message to a node 104 may include sending the message directly to the node 104. Propagating a message to a node 104 may include sending the message to a network address (e.g. an IPv4 or IPv6 address) to associated with the node 104. Propagating a message to a node 104 may include sending the message to a network address (e.g. an IPv6 multicast address) to which the node 104 is subscribed. It will be appreciated that “sending a message to a network address” may be taken to mean sending a message (e.g. to a router), where the message is addressed to the network address.

The first node 104a obtains a first message. The first message may be received from a different node 104 or from a user 103. In some examples, the first message may be generated, at least in part, by the first node 104a. For instance, the first message may include a block header generated by the first node 104a based on a set of validated transactions available to the first node 104a, e.g. stored in its mempool.

In some embodiments, the first node 104a is associated with a first number range. In general the first number range may begin and end with any number, and be of any size. The first number range may be chosen by the first node 104a, or by a different node 104, or by a third party. In some examples, several (e.g. all) nodes 104 of the blockchain network 106 determine the first number range. Each node 104 may be associated with its own number range. Some of the number ranges may overlap. Some of the number ranges may not overlap.

The first node 104a determines a first number based on the first message. For example, the first node 104a may apply a hash function to the first message and determine the first number based on the hash result, e.g. by generating the first number based on the hash result, or selecting one or more digits of the hash result (such as the leading non-zero digit or final digit). In some examples, the first number is determined based on part (e.g. a field) of the first message. That is, the first message may include a number on which the first number may be based. As a particular example, the first message may be a transaction and he first number may be determined based on the transaction identifier, e.g. one or more of the first or last digits of the transaction identifier.

If the first number, determined based on the first message, falls within the first number range, the first node 104 propagates the first message to one or more second nodes 104 (e.g. “Blockchain Node B” 104v and “Blockchain Node C” 104c). Conversely, if the first number does not fall within the first number range, the first node 104a does not propagate the first message to one or more second nodes 104. That is, the first node 104a only forwards the first message if the first number is within the number range assigned to the first node 104a.

As discussed above, propagating the first message may involve sending the first message to the one or more second nodes 104. Alternatively, as shown in FIG. 4, propagating the first message may involve sending the first message to a first network address (e.g. “Network Address A) associated with the first number range. One or more second nodes 104 may listen to (e.g. subscribe to) the first network address for blockchain messages. That is, one or more second nodes 104 may choose to monitor the first network address for messages, or messages sent to the first network address may be forwarded to nodes 104 that are subscribed to the first network address.

Each number range may be associated with a respective network address. Each node 104 may determine a number based on a message it receives, and only propagate messages if the number falls within the range assigned to that node. Here, propagating means sending the message to the appropriate network address. As shown in FIG. 4, a given node 104 may subscribe to multiple network addresses. Similarly, multiple nodes 104 may subscribe to the same network address. For instance, the network address may be a (IPv6) multicast address.

In other embodiments, the first node 104a is associated with a first set of blockchain nodes 104 (i.e. one or more nodes 104 other than the first node 104a). In general the first set of nodes 104 may include any number of nodes 104, but does not include every node 104. The first set of nodes (the particular nodes 104 and/or the number of nodes 104) may be chosen by the first node 104a, or by a different node 104, or by a third party. In some examples, several (e.g. all) nodes 104 of the blockchain network 106 determine the first set of nodes 104. Each node 104 may be associated with its own set of other nodes 104. Some of the sets may overlap. Some of the sets may not overlap.

Note that as used throughout the present disclosure, the term “set” may be taken to mean one or more.

The first node 104a is configured to propagate a first message to each of the nodes 104 in the first set of nodes 104. The first node 104a does not propagate the first message to nodes 104 not belonging to the first set of nodes 104. That is, the first node 104a only forwards the first message to one or more second nodes 104 assigned to the first node 104a.

As discussed above, propagating the first message may involve sending the first message to the one or more second nodes 104. Alternatively, as shown in FIG. 4, propagating the first message may involve sending the first message to a first network address (e.g. “Network Address B) associated with the first set of nodes 104. One or more second nodes 104 may listen to (e.g. subscribe to) the first network address for blockchain messages. That is, one or more second nodes 104 may choose to monitor the first network address for messages, or messages sent to the first network address may be forwarded to nodes 104 that are subscribed to the first network address.

Each set of nodes 104 may be associated with a respective network address. Each node 104 may only propagate messages to the set of nodes 104 assigned to that node 104. Here, propagating means sending the message to the appropriate network address. As shown in FIG. 4, a given node 104 may subscribe to multiple network addresses. Similarly, multiple nodes 104 may subscribe to the same network address. For instance, the network address may be a (IPv6) multicast address.

In other embodiments, the first node 104a is associated with both a first number range and a first set of nodes 104. Similar to the embodiments described above, the first node 104a may determine a first number based on a first blockchain message and only propagate the first message to the first set of nodes 104 if the first number falls within the first number range.

In some embodiments, the first node 104a is associated with multiple number ranges and multiple sets of nodes. For example, the first node 104a may be associated with a first number range linked to (i.e. associated with) a first set of nodes 104, a second number range linked to a second set of nodes 104, a third set of nodes 104 linked to a third set of nodes 104, and so on. In general the first node 104a may be associated with any number of respective number ranges and respective sets of nodes 104.

As in the embodiments described above, each respective number range may begin and end with any number, and be of any size. One or more of the respective number ranges may overlap. One or more of the respective number ranges may not overlap. One or more of the respective number ranges may be chosen by the first node 104a, or by a different node 104, or by a third party. In some examples, several (e.g. all) nodes 104 of the blockchain network 106 may determine one or more of the respective number ranges.

Similarly, like the embodiments described above, each respective set of nodes 104 may include any number of nodes 104, but does not include every node 104. One or more of the respective sets may include the same number of nodes 104. One or more of the respective sets may include a different number of nodes 104. One or more of the respective sets of nodes (the particular nodes 104 and/or the number of nodes 104) may be chosen by the first node 104a, or by a different node 104, or by a third party. In some examples, several (e.g. all) nodes 104 of the blockchain network 106 determine one or more of the respective sets of nodes 104.

For each message that the first node 104a obtains (e.g. receives or generates), the first node 104a determines a respective number for that message. The first node 104a may determine the respective numbers using any of the techniques described above, e.g. by hashing part of all of the message. If the respective number is within one of the respective number ranges, the first node 104a may propagate the respective message to the respective set of nodes 104 linked to the respective number range.

In some examples, the first node 104a may propagate each message to the respective set of nodes linked to a respective number range if the respective number determined for that message falls within the respective number range. In other examples, the first node 104a may only propagate some of the messages to the respective set of nodes. For example, the first node 104a may propagate only 50% of the messages having determined numbers falling within a particular number range to the associated set of nodes 104. In some examples, each number range is associated with a respective percentage which dictates the proportion of messages that are sent to the respective set of nodes 104. For instance, if a number range is associated with 25%, then only 25% of the messages having determined numbers falling within that number range are sent to the respective set of nodes 104. One or more respective number ranges may be associated with the same percentage. One or more respective number ranges may be associated with a different percentage. In some examples, each respective number range is associated with a different percentage.

Like the embodiments described above, propagating the respective messages may involve sending the respective messages to the one or more second nodes 104 belonging to the respective sets. Alternatively, as shown in FIG. 4, propagating the respective messages may involve sending the respective messages to a respective network address associated with the respective set of nodes 104. For example, as shown in FIG. 4, a message may be sent to Network Address A to which nodes 104b and 104c are subscribed to, i.e. listen to for messages, whilst a different message may be sent to Network Address B to which nodes 104c and 104d are subscribed to. Each second nodes 104 may listen to (e.g. subscribe to) one or more network addresses for blockchain messages.

### 1.1 Specific Examples

As discussed, the described embodiments reduce the total instantaneous traffic in the blockchain network 106 by modifying the P2P messaging protocol such that new block and transaction messages are not unnecessarily duplicated. Specific examples of the described embodiments are now discussed. Features that unify these examples are the following:
Every data message (i.e. blocks, transactions) is sent from a source node 104 to a Multicast address.
A node 104 will selectively send data messages depending on a policy rule. The node's policy rule determines whether a node 104 send a given message, or to which nodes 104 a given message is sent, be based on:
   (i) the content of the data message; or
   (ii) the groups of nodes currently in the network; or
   (iii) both.

Note that there may be some exceptional messages, such as when a node 104 itself finds a new block, which may be exempt from this new logic.

### 1.1.1 Example Policy 1—Content-Based Message Propagation

In this example, the P2P protocol is modified such that a node 104 is assigned a numeric range for which it is responsible for forwarding messages. Since a number may be derived from each data message received by a node 104 (e.g. by hashing the message), the P2P protocol automatically chooses to propagate only messages whose numeric value falls within the node's assigned range.

The logic for selectively propagating data messages in the new P2P protocol is as follows:
0. A node A is assigned a numeric range R:=[v_{L}, v_{U}]∈ [symbol] ₖ
1. A receives a data message m from another network node or from a user.
2. A finds or computes a hash of the message h(m).
3. A parses h(m) as a number in the range 0≤h(m)≤k, where k is determined by the hash function h.
4. If h(m)∈[v_{L}, v_{U}], send m to the Multicast IP address IP_{R}, else do nothing.

Notes about this protocol variant:
The range R may be self-assigned to a node 104 (e.g. randomly chosen) when joining the network. Alternatively, it can be assigned by a 3^{rd} party service provider that monitors which nodes are responsible for which ranges at a given time. Alternatively, nodes 104 can communicate cooperatively to assign ranges together on an ongoing and dynamic basis to ensure the full range is always covered.
There may be overlap in the ranges covered by different nodes 104. Minimising the overlap will minimise the redundancy in message propagation.
The Multicast IP address corresponding to this range IP_{R} may be subscribed to by any network node 104. If there is no overlap in ranges, preferably all nodes 104 would subscribe to this address to ensure they will all receive all data messages. If there are overlaps, then nodes 104 that are a source for a given range will not need to subscribe, minimising redundant traffic.

In this P2P protocol, it is preferable for a node 104 to subscribe for every range-specific Multicast address for which the node 104 is not also a source.

### 1.1.2 Protocol Variant 2—Group-Based Propagation

In this example, the P2P protocol is modified such that each node 104 is assigned a group of nodes to whom it must forward messages.

The logic for selectively propagating data messages in the new P2P protocol is as follows:
0. A node A is assigned a group of recipient nodes range [symbol] ={Bᵢ}, who share a corresponding Multicast address I [symbol]
1. A receives a data message m from another network node or from a user.
2. A forwards m to the Multicast address I

[symbol]

Notes about this protocol variant:
The selectivity in this variant affects the choice of which nodes 104 to forward messages to, and not which messages to propagate.
Similar to protocol variant 1, the group [symbol] assigned to a node 104 may be either (i) self-assigned, (ii) assigned by a third party), or (iii) collaboratively assigned in coordination with the rest of the node network 106.
If all nodes 104 are assigned a group of at least one node 104 to send messages to then there is still some redundancy in traffic, but it is significantly reduced compared to the worst case scenario.

### 1.1.3 Protocol Variant 3—Combined

An alternative is to modify the P2P messaging protocol using a combination of variants one and two, whereby messages may be (i) selectively chosen for propagation; and (ii) given that they are selected they are propagated to only a selected group of nodes 104.

For instance, a modified version of the P2P protocol can be established that implements the following rule set, for a given node A:
1. A will propagate all messages in the range [v_{L}, v_{U}] to the group [symbol] .
2. A will propagate 50% of messages in the range

$$[ {v}_{L}^{′} , {v}_{U}^{′} ]$$

to the group [symbol] .
3. A will propagate 25% of messages in the range

$$[ {v}_{L}^{″} , {v}_{U}^{″} ]$$

to the group [symbol] .
4 . . . .

Such logic allows increased network consistency and resilience to failures at the cost of a corresponding increase in redundancy, but crucially with less redundancy that the current P2P protocol tolerates. Such a scheme also allows the degree of redundancy to be finely tuned by selecting the size of each range and the size of each group as a parameter, and by reflecting the diversity in node capabilities on the network in the respective values chosen for these parameters by each node 104.

### 1.1.4 Exceptions

There may be exceptions to the P2P logic variants presented above, such as new blocks generated by a node 104 which should be broadcast widely by that node 104 to the entire network as quickly as possible.

To account for such cases, message-specific Multicast addresses may be created to which other nodes 104 subscribe. Each node Aᵢ can register a specific address

$${IP}_{{A}_{i}}^{*}$$

corresponding to new blocks creates by Aᵢ. All nodes Aⱼ on the network would subscribe to

$${IP}_{{A}_{i}}^{*} ∀ i \neq j ,$$

and Aᵢ will send new block messages exclusively to

$${IP}_{{A}_{i}}^{*} .$$

This ensures that new blocks are not disadvantaged by the proposed P2P protocol changes and their orphan risk not increased.

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

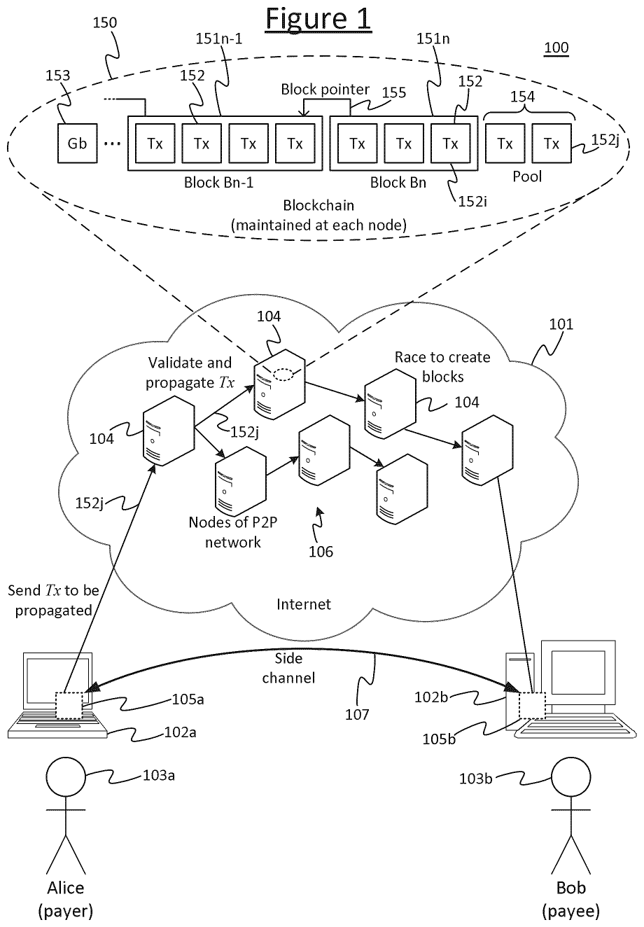

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

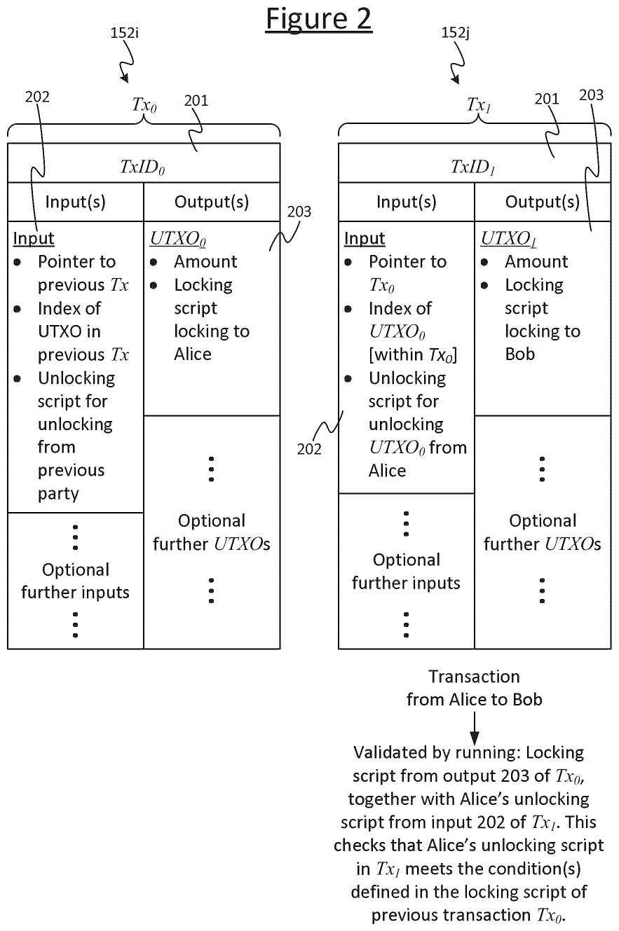

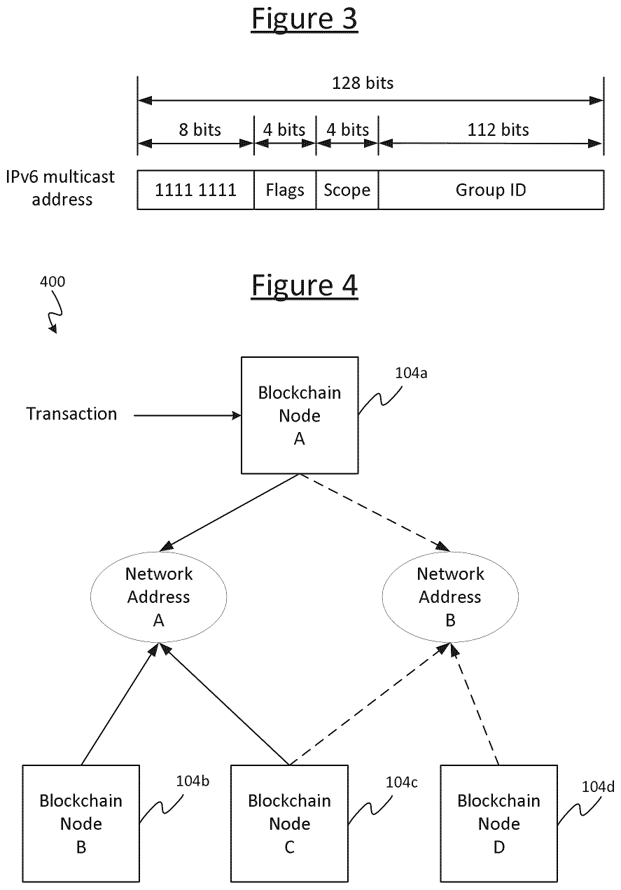

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “T_{X1}”. It takes an amount of the digital asset that is locked to Alice in the output 203 of a preceding transaction 152i in the sequence, and transfers at least some of this to Bob. The preceding transaction 152i is labelled “T_{X0}” in FIG. 2. T_{X0} and T_{X1} are just arbitrary labels. They do not necessarily mean that T_{X0} is the first transaction in the blockchain 151, nor that T_{X1} is the immediate next transaction in the pool 154. T_{X1} could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction T_{X0} comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of T_{X0} comprises a locking script [Checksig PA] which requires a signature Sig PA of Alice in order for UTXO₀ to be redeemed (strictly, in order for a subsequent transaction attempting to redeem UTXO₀ to be valid). [Checksig PA] contains a representation (i.e. a hash) of the public key PA from a public-private key pair of Alice. The input 202 of T_{X1} comprises a pointer pointing back to T_{X1} (e.g. by means of its transaction ID, TxID₀, which in embodiments is the hash of the whole transaction T_{X0}). The input 202 of T_{X1} comprises an index identifying UTXO₀ within T_{X0}, to identify it amongst any other possible outputs of T_{X0}. The input 202 of T_{X1} further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction T_{X1} arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.
Statement 1. A computer-implemented method of propagating blockchain messages, wherein a blockchain network comprises a plurality of blockchain nodes, wherein each blockchain node is associated with a respective set of blockchain nodes, wherein the method is performed by a first blockchain node and comprises:
   making a first blockchain message available to each blockchain node belonging to the respective set of blockchain nodes associated with the first blockchain node, wherein the respective set of blockchain nodes comprises some but not all of the plurality of blockchain nodes.

The method comprises not making the first blockchain message available to those blockchain nodes belonging to a respective set of blockchain nodes not associated with the first blockchain node.
Statement 2. The method of statement 1, wherein each respective set of blockchain nodes is associated with a respective network address, and wherein said making the first blockchain message available to each blockchain node belonging to the respective set of blockchain nodes associated with the first blockchain node comprises sending the first blockchain message to the respective network address associated with the respective set of blockchain nodes.
Statement 3. A computer-implemented method of obtaining blockchain messages, wherein a blockchain network comprises a plurality of blockchain nodes, wherein the method is performed by a second blockchain node and comprises:
   subscribing to a respective network address associated with a respective set of blockchain nodes; and
   obtaining a first blockchain message sent to the respective network address.

Subscribing may comprise listening to/monitoring the respective network address.
Statement 4. The method of any preceding statement, wherein the respective set of blockchain nodes associated with each blockchain node is self-assigned by the blockchain node.
Statement 5. The method of any of statements 1 to 4, wherein the respective set of blockchain nodes associated with each blockchain node is assigned by a third party.
Statement 6. The method of any of statements 1 to 5, wherein the respective set of blockchain nodes associated with each blockchain node is assigned collectively by multiple of the plurality of blockchain nodes.
Statement 7. The method of statement 2 or statement 3, or any statement dependent thereon, wherein the respective network address is a multicast address.
Statement 8. The method of statement 7, wherein the multicast address is an IPv6 multicast address.
Statement 9. The method of any preceding statement, wherein the first blockchain message comprises a blockchain transaction.
Statement 10. The method of any preceding statement, wherein the first blockchain message comprises a blockchain block.
Statement 11. Computer equipment comprising:
   memory comprising one or more memory units; and
   processing apparatus comprising one or more processing units, wherein the memory stores code arranged to run on the processing apparatus, the code being configured so as when on the processing apparatus to perform the method of any of statements 1 to 10.
Statement 12. A computer program embodied on computer-readable storage and configured so as, when run on one or more processors, to perform the method of any of statements 1 to 10.

According to another aspect disclosed herein, there may be provided a method comprising the actions of the first blockchain node and the second blockchain node. According to another aspect disclosed herein, there may be provided a system comprising the computer equipment of the first blockchain node and the second blockchain node.

1. A computer-implemented method of propagating blockchain messages, wherein a blockchain network comprises a plurality of blockchain nodes, wherein each blockchain node is associated with a respective set of blockchain nodes, wherein the method is performed by a first blockchain node and comprises:
making a first blockchain message available to each blockchain node belonging to the respective set of blockchain nodes associated with the first blockchain node, wherein the respective set of blockchain nodes comprises some but not all of the plurality of blockchain nodes.

2. The method of claim 1, wherein each respective set of blockchain nodes is associated with a respective network address, and wherein said making the first blockchain message available to each blockchain node belonging to the respective set of blockchain nodes associated with the first blockchain node comprises sending the first blockchain message to the respective network address associated with the respective set of blockchain nodes.

3. A computer-implemented method of obtaining blockchain messages, wherein a blockchain network comprises a plurality of blockchain nodes, wherein the method is performed by a second blockchain node and comprises:
subscribing to a respective network address associated with a respective set of blockchain nodes; and
obtaining a first blockchain message sent to the respective network address.

4. The method of claim 3, wherein the respective set of blockchain nodes associated with each blockchain node is self-assigned by the blockchain node.

5. The method of claim 3, wherein the respective set of blockchain nodes associated with each blockchain node is assigned by a third party.

6. The method of claim 3, wherein the respective set of blockchain nodes associated with each blockchain node is assigned collectively by multiple of the plurality of blockchain nodes.

7. The method of claim 3, wherein the respective network address is a multicast address.

8. The method of claim 7, wherein the multicast address is an IPv6 multicast address.

9. The method of claim 3, wherein the first blockchain message comprises a blockchain transaction.

10. The method of claim 3, wherein the first blockchain message comprises a blockchain block.

11. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a computer-implemented method of propagating blockchain messages, wherein a blockchain network comprises a plurality of blockchain nodes, wherein each blockchain node is associated with a respective set of blockchain nodes, wherein the method is performed by a first blockchain node and comprises:
making a first blockchain message available to each blockchain node belonging to the respective set of blockchain nodes associated with the first blockchain node, wherein the respective set of blockchain nodes comprises some but not all of the plurality of blockchain nodes.

12. A computer program embodied on non-transitory computer-readable storage medium and configured so as, when run on one or more processors, the one or more processors perform a computer-implemented method of propagating blockchain messages, wherein a blockchain network comprises a plurality of blockchain nodes, wherein each blockchain node is associated with a respective set of blockchain nodes, wherein the method is performed by a first blockchain node and comprises:
making a first blockchain message available to each blockchain node belonging to the respective set of blockchain nodes associated with the first blockchain node, wherein the respective set of blockchain nodes comprises some but not all of the plurality of blockchain nodes.

13. The method of claim 1, wherein the respective set of blockchain nodes associated with each blockchain node is self-assigned by the blockchain node.

14. The method of claim 1, wherein the respective set of blockchain nodes associated with each blockchain node is assigned by a third party.

15. The method of claim 1, wherein the respective set of blockchain nodes associated with each blockchain node is assigned collectively by multiple of the plurality of blockchain nodes.

16. The method of claim 2, wherein the respective network address is a multicast address.

17. The method of claim 16, wherein the multicast address is an IPv6 multicast address.

18. The method of claim 1, wherein the first blockchain message comprises a blockchain transaction.

19. The method of claim 1, wherein the first blockchain message comprises a blockchain block.
